(19) United States
(12) Patent Application Publication
(10) Pub. No.: US 2024/0181368 A1
(43) Pub. Date: Jun. 6, 2024

(54) SYSTEM AND METHOD FOR SEPARATING WATER AND SALT BY SEQUENTIAL EVAPORATION OF MULTIPLE GROUPS OF HEAT COLLECTING DEVICES

(71) Applicant: ZHEJIANG UNIVERSITY, Hangzhou (CN)

(72) Inventors: Zhilin SUN, Hangzhou (CN); Yizhi SUN, Hangzhou (CN); Chaoqun ZHAI, Hangzhou (CN)

(21) Appl. No.: 18/493,813

(22) Filed: Oct. 25, 2023

(30) Foreign Application Priority Data
Oct. 25, 2022 (CN) 202211311711.1

(51) Int. Cl. B01D 1/00; B01D 1/12

(52) U.S. Cl. CPC B01D 1/0035; B01D 1/0064; B01D 1/0082; B01D 1/0088; B01D 1/0094; B01D 1/12

(57) ABSTRACT

A system and a method for separating water and salt by sequential evaporation of multiple groups of heat collecting devices. The system comprises heat collectors, a light-gathering heat collector, a heating chamber, an evaporation chamber, a condenser, a buffer chamber and a vacuum pump; a saline water stock solution is rapidly heated by multiple series-connected-multiple groups of parallel solar heat collecting devices and series-connected light-gathering heat collectors with decreasing water levels, and the water levels control water inlet and the temperature controls water outlet; several groups are started up in turn to perform micro-negative pressure evaporation, while other groups provide phase change heat energy, and the buffer chamber collects concentrated saline water; natural convection heat exchange occurs between the saline water stock solution and a vapor manifold, vapor heat energy is recovered and condensed fresh water is produced.

### CROSS-REFERENCE TO RELATED APPLICATIONS

The present application claims priority to Chinese Patent Application No. 202211311711.1, filed on Oct. 25, 2022, the content of which is incorporated herein by reference in its entirety.

### TECHNICAL FIELD

The present application relates to the field of water resources and water treatment, in particular to a system and a method for separating water and salt by sequential evaporation of multiple groups of heat collecting devices.

### BACKGROUND OF THE INVENTION

With the rapid growth of population and industrial development, the global shortage of fresh water and soil salinization have become the two most urgent challenges facing human society. Desalination and salt making are one of the most effective means to solve these two problems.

Most of the existing saline water treatment methods only aim at one direction, that is, only desalination and water intake, or only crystallization and salt production. Only the saline water from water is treated, and after the water and salt are separated to obtain the required fresh water, the concentrated saline water will be directly discharged into the sea or underground or on the ground, which will lead to more serious soil salinization, pollution to the marine environment, influence the survival of marine life and pollute groundwater. Saline water treatment for salt production only consumes a lot, and the generated vapor is directly discharged into the environment, which directly wastes the energy of vapor and is also a waste of fresh water resources.

In the field of saline water desalination, it is mainly divided into distillation desalination and membrane desalination. Specifically, distillation desalination technology includes MVR technology and multi-effect evaporation technology. MVR technology obtains power through the recompression of vapor to separate water and salt, which has enough mechanical power to distill saline water, but it consumes more energy and has higher operating cost. Multi-effect evaporation technology can achieve the purpose of separating water and salt by series evaporation of multiple evaporation chambers. The equipment is simple and the operation flexibility is great, but it requires gradual pressure reduction, requires high vacuum, and needs more electric energy and other mechanical energy as power support, so it cannot be used in areas lacking stable and continuous large amount of electric power resources. Membrane desalination does not need heating. Compared with traditional distillation technology, membrane desalination is simpler and more efficient, and water-salt separation treatment is more stable, but the membrane cost is high and power consumption is high.

In the field of salt production by crystallization, there are two main methods: salt field method and electrodialysis method. The salt field method is to use a large number of open spaces, so that saline water can be directly exposed to the sun on the flat ground to evaporate water and produce crystal salt. Although this method does not need electric energy and other mechanical energy, it is too slow, occupies a large area, is inefficient and is unstable in salt production. The electrodialysis method occupies a small area, does not depend on the weather, and the product quality is high, but it needs a lot of electricity, the cost is high and scaling tends to occur.

### SUMMARY OF THE INVENTION

In view of the shortcomings of the prior art, the present application provides a system and a method for separating water and salt by sequential evaporation of multiple groups of heat collecting devices, so as to solve the problems of low saline water treatment efficiency, high cost, large energy consumption, low single concentration and the like.

In order to achieve the above purpose, the technical solution adopted by the present application is as follows:

An embodiment of the present application provides a system for separating water and salt by sequential evaporation of multiple groups of heat collecting devices, including a water storage tank and multiple groups of heat collecting devices, light-gathering heat collectors, a heating chamber, an evaporation chamber, a condenser, a buffer chamber, a concentrated saline water tank, a fresh water tank and a vacuum pump. The water storage tank is configured for storing a low-temperature saline water stock solution, and an outlet of the water storage tank is connected with a three-way tube to form two paths, one path being connected with an inlet of an inner tube of the condenser, and the other path being connected with an inlet of a first heat collector of each group of heat collecting devices; the system comprises M groups of heat collecting devices, each group of heat collecting devices consisting of N heat collectors connected in series, there are a total of MN heat collectors, and the M groups of heat collecting devices are connected in parallel; the light-gathering heat collector consists of a parabolic lens and a vacuum tube, and is arranged between the heat collecting device and the heating chamber as an auxiliary heating device; an inlet of the light-gathering heat collector is connected with an outlet of a N^{th} heat collector of each heat collecting device; an outlet of the light-gathering heat collector is connected with a shell-side inlet of the heating chamber, and a communication port is provided with a non-return control valve with a flowmeter; the heating chamber has a shell-and-tube structure, a tube-side inlet of the heating chamber is connected with an outlet of a

$$INT {⌊ \frac{{T}_{v} - {T}_{1}}{{T}_{v} - {T}_{0}} N + 1 ⌋}_{th}$$

heat collector of each group of heat collecting devices, and each communication port is provided with a non-return control valve with a flowmeter; a shell-side outlet of the heating chamber is connected with an inlet of a

$$INT {⌊ \frac{( {T}_{v} + α ) - {T}_{1}}{( {T}_{v} + α ) - {T}_{0}} N + 1 ⌋}_{th}$$

heat collector of each group of heat collecting devices, where INT└ ┘ is a rounding down symbol, Tᵥ is a phase change temperature of saline water corresponding to a given evaporation chamber pressure, T₀ is a given initial stock solution temperature, T₁ is an outlet temperature of the first heat collector; where α is a temperature margin, taking 2-4° C.; an inlet of the evaporation chamber is connected with the tube-side outlet of the heating chamber; the evaporation chamber has two outlets, a top vapor outlet being connected with the condenser, and a bottom concentrated solution outlet is connected with the buffer chamber; the condenser has a sleeve-type structure, a tube ring inlet between an inner tube and an outer tube is connected with the vapor outlet of the evaporation chamber, and a tube ring outlet is connected with the fresh water tank; an inlet of the inner tube is connected with the water storage tank, and an outlet is connected with an inlet of a

$$INT {⌊ \frac{{T}_{c} - {T}_{1}}{{T}_{c} - {T}_{0}} N + 1 ⌋}_{th}$$

heat collector of each heat collecting device, where T_{c} is an outlet temperature of the condenser; a mathematical expression for determining the outlet temperature is as follows:

$${T}_{c} = {T}_{0} + \frac{r}{{c}_{p} ( M - 1 )}$$

where cₚ is a specific heat capacity of saline water, r is latent heat of vapor corresponding to a pressure Pᵥ; the outlet of the buffer chamber is provided with a floating ball self-opening valve, which is connected with the concentrated saline water tank; a suction port of the vacuum pump is provided at the top of that fresh wat tank, and an exhaust valve is provided at the bottom thereof; the vacuum pump is connected to the top of the fresh water tank, so that the evaporation chamber and tube rings of the condenser are in a micro-negative pressure environment.

Further, the M groups of heat collecting devices are arranged in parallel, each group of heat collecting devices is cascade-connected by N vacuum tube-type heat collectors in series, and each of the heat collectors is mainly composed of several vacuum heat-collecting tubes and a water tank; the water tank of the first heat collector is filled with water body; a cross-sectional area of the water body of the water tank of the first heat collector is A₁, and a cross-sectional area of the water body of the water tank of a i(=1˜N−1)^{th} heat collector is

$${A}_{i} = ( 1 - \frac{i - 1}{N} ) {A}_{1} ,$$

a cross-sectional area of the water body of the water tank of a i+1^{th} heat collector is smaller than that of a i^{th} heat collector by

$$\frac{{A}_{1}}{N} ,$$

and water levels are gradually decreasing; a bottom height h₁ of the outlet of the water tank of the heat collector first heat collector is flush with the water level of the second heat collector, and a bottom height hᵢ of the outlet of the water tank of the i(=2˜N)^{th} heat collector is determined by the following formula:

$$\frac{i - 1}{N} {A}_{1} = 2 {\int }_{{h}_{i}}^{2 R} \sqrt{{R}^{2} - {( y - R )}^{2}} dy$$

where 0<hᵢ<2R , R is a cross-sectional radius of the water tank, y is a vertical direction, and upward is positive; a water outlet control valve is arranged at the outlet of the water tank of the first heat collector of each group of heat collecting devices, and a temperature sensor is arranged below a water surface of the water tank of the N^{th} heat collector; when the temperature sensor in the N^{th} heat collector measures the water temperature as T_{N}≥T_{b}±2° C., where T_{b} is a boiling point temperature of saline water corresponding to a given initial salinity C₀ and an atmospheric pressure, the water outlet control valve is opened, the saline water with a temperature higher than T₀+ΔT₁ in an upper part of the water tank of first heat collector flows into the bottom of the water tank of the second collector, the water level of the water tank of the second heat collector rises accordingly, and the saline water higher than the bottom height of the outlet flows into a third heat collector from the outlet; therefore, the water body of the water tank of a i(=3˜N−1)^{th} heat collector flows into the water tank of a i+1^{th} heat collector by itself, and finally the water tank of the N^{th} heat collector receives the high-temperature saline water flowing from the water tank of a N−1^{th} heat collector by itself, and the saline water then enters the light-gathering heat collector, so that the water temperature can be further increased to meet the temperature requirements of a heat source; and the temperature of saline water flowing from the water tank of the i(=1˜N−1)^{th} heat collector is the same as a lowest temperature of saline water in the water tank of the i+1^{th} heat collector.

Further, a water inlet control valve is arranged at the inlet of the water tank of the first heat collector of the m(=1˜M)^{th} group of heat collecting devices, and water level sensors are arranged at the bottom heights of the water outlets of the water tanks of the N−1^{th} and N^{th} heat collectors respectively; when the water level sensor of the water tank of the N−1^{th} or N^{th} heat collector senses that the water level is lower than the bottom height of the outlet of the water tank, the water inlet control valve is opened, and the water storage tank starts to add water to the first heat collector water tank, until the water level sensor senses that the water level is replenished, and then the water inlet control valve is closed; the inlet water level control in each group of heat collecting devices takes precedence over the outlet temperature control, and the two types of control are allowed to be triggered simultaneously; a height of the outlet of the light-gathering heat collector is higher than that of the shell-side inlet of the heating chamber; a height of the tube ring inlet of the condenser is higher than that of the vapor outlet of the evaporation chamber, a height of the tube ring outlet of the condenser is higher than that of the inlet of the fresh water tank, a height of the outlet of the concentrated solution of the evaporation chamber is higher than that of the inlet of the buffer chamber, and a height of the outlet of the buffer chamber is higher than that of the inlet of the concentrated saline water tank.

An embodiment of the present application further provides a method for separating water and salt by sequential evaporation of multiple groups of heat collecting devices, including the following steps:
(1) heat temperature rise of multi groups of heat collecting devices: low-temperature saline water stock solution is heated to raise a temperature of the saline water in a manner of two light-gathering heat temperature rise modes by series-connected-multiple groups of parallel solar heat collecting devices and series-connected light-gathering heat collectors with decreasing water levels;
(2) micro-negative pressure sequential evaporation: the saline water heated in the step (1) passes through a heating chamber and an evaporation chamber to realize micro-negative pressure evaporation, and vapor and a concentrated solution of extractable crystal salt are obtained;
(3) self-convection phase change condensation: the vapor obtained in the step (2) is further introduced into a condenser, and fresh water is obtained by phase change through reverse self-convection heat exchange with a low-temperature saline water stock solution, and at the same time, the low-temperature saline water stock solution obtains a certain temperature rise, enters the heat collecting device, and continues to participate in light-gathering heat temperature rise;
(4) cycle operation: a first system cycle of steps (1) to (3) is completed, and M times of cycles are repeated so that the sequential evaporation of the saline water stock solution in each group of heat collecting devices can be completed, and water vapor separation, fresh water and concentrated saline water collection can be continuously carried out.

Further, in step (1), the heat temperature rise of the multiple groups of heat collecting devices is specifically as follows: a group of heat collecting devices is formed by connecting N solar heat collectors in series, with a total of M groups of heat collecting devices; a temperature rise of a i(=1˜N)^{th} heat collector of each group of heat collecting devices is

$$Δ {T}_{i} = \frac{{V}_{1}}{{V}_{i}} \cdot Δ {T}_{1} ,$$

a temperature rise of a first heat collector is

$$Δ {T}_{1} = \frac{{V}_{N}}{{V}_{1}} Δ {T}_{N} ,$$

where ΔT_{N} a given temperature rise of a N^{th} heat collector, V₁, Vᵢ, V_{N} are the water quantities of the first, i^{th} and N N^{th} heat collectors respectively; the heat received by the unit water body in i+1^{th} water tank is higher than that in a i(=1˜N−1)^{th} water tank by

$$KN Δ {T}_{1} ( \frac{1}{N - i} - \frac{1}{N - i + 1} ) ,$$

where K is a heat transfer coefficient; the light-gathering heat collector is an auxiliary heating device, and the saline water in the N^{th} heat collector of each group of heat collecting devices first flows through the light-gathering heat collector to absorb solar light to be heated again, so that the temperature of the heat source entering a shell side of the heating chamber T_{con}≥T_{b}, where T_{con} is an outlet temperature of the light-gathering heat collector.

Further, in step (2), the sequential evaporation by micro-negative pressure is specifically as follows: the saline water in a

$$INT {⌊ \frac{{T}_{v} - {T}_{1}}{{T}_{v} - {T}_{0}} N + 1 ⌋}_{th}$$

heat collector of a m(=1˜M)^{th} group of heat collecting devices is rotated in a sequence of 1˜M, and enters a tube side of the heating chamber to serve as a liquid to be phase-changed, and at the same time an outlet valve of the N^{th} heat collector of the group of heat collecting devices is closed; saline water with a temperature of T_{b} in the N^{th} heat collector of the other M−1 groups of heat collecting devices except the m^{th} group flows through the light-gathering heat collector, that is, the saline water naturally flows from an outlet of the light-gathering heat collector into the inlet of the shell side of the heating chamber as the heat source of the shell side of the heating chamber to heat the heated liquid in the tube side of the heating chamber; a flow rate of one part of the liquid to be phase-changed with a flow quantity of q₀ and a temperature of Tᵥ circulating in the tube side of the heating chamber is controlled as u₀, a flow rate of the heat source with a flow quantity of (M−1)qₛ and a temperature of T_{b} circulating in the shell side is controlled as uₛ, the relationship between the two flow rates satisfying

$$\frac{{u}_{s}}{{u}_{0}} = \frac{2}{M - 1} \frac{r ( 1 - {C}_{0} / {C}_{1} )}{{c}_{p} [ {T}_{b} - ( {T}_{v} + α ) ]} ,$$

where C₀ and C₁ are respectively an initial salinity of saline water to be phase-changed and a salinity of concentrated solution, and the salinity C₁ is close to saturation salinity; the saline water as a heat source flows out of the heating chamber after heat transfer and cooling, returns to a

$$INT {⌊ \frac{( {T}_{v} + α ) - {T}_{1}}{( {T}_{v} + α ) - {T}_{0}} N + 1 ⌋}_{th}$$

heat collector of the (M−1)^{th} group of heat collecting devices as a heat source according to a flow quantity of qₛ per part, and continues to participate in the sequential heating; after the sequential starting, the saline water entering the tube side of the heating chamber as the liquid to be phase-changed flows out of the heating chamber and enters the evaporation chamber, and the evaporation chamber performs evaporation and water-vapor separation for one part of the vapor-containing saline water to be phase-changed with a temperature of Tᵥ that flows out of the tube of the heating chamber under a given negative pressure Pᵥ; the vapor in the evaporation chamber is discharged from the outlet at the top of the evaporation chamber and flows between the tube rings of the condenser; the remaining saline water whose salinity is concentrated to C₁ flows into a buffer chamber controlled by a float self-opening valve through the outlet at the bottom of the evaporation chamber; when a weight of the saline water in the buffer chamber reaches a preset value, the float valve is self-opened under pressure, and then the concentrated solution with a nearly saturated salinity flows into a concentrated saline water tank for extracting crystal salt.

Further, in the step (3), the self-convection phase change condensation is specifically as follows: the condenser is divided into a tube ring vapor passage and an inner tube saline water passage; the vapor in the tube ring passage enters the tube ring from a lower inlet of the condenser, naturally floats from bottom to top, and is condensed into fresh water by exothermic phase change, and then flows into the fresh water tank through a water inlet at a lower end of the tube ring passage; the low-temperature saline water stock solution in the inner tube passage is provided by the water storage tank, enters an inner tube from an inlet at an upper end of the condenser, naturally flows from top to bottom, and forms natural counter-convection with the vapor in the tube ring passage, a total amount of the low-temperature saline water stock solution being Mq_{c}; the low-temperature saline water stock solution in the inner tube passage flows out from the outlet at the lower end of the inner tube passage after exchanging heat with vapor and heating, and flows into a

$$INT {⌊ \frac{{T}_{c} - {T}_{1}}{{T}_{c} - {T}_{0}} N + 1 ⌋}_{th}$$

heat collector of M groups of heat collecting devices according to a flow quantity of q_{c} per part to participate in sequential heating; the fresh water tank is configured for storing fresh water which is formed by the phase change of vapor in the condenser, and the fresh water tank is provided with an exhaust valve which is always closed when the system is running to maintain the negative pressure environment of the evaporation chamber and the condenser; at the end of the system operation, the exhaust valve is opened, so that the air pressure in the fresh water tank becomes a normal pressure and fresh water flows out.

The present application has the following beneficial effects:

In the heat collection process, series-connected-multiple groups of parallel solar heat collecting devices and series-connected light-gathering heat collectors with decreasing water levels are adopted, and a plurality of solar heat collectors are connected in series with cascade decreasing water levels are used for heating, so that the temperature rise is doubled, natural flow is realized by potential energy difference, energy consumption is not required, energy is effectively saved, and the heat collection efficiency is improved; the saline water heated by the series-connected-multiple groups of parallel solar heat collecting devices with decreasing water levels enters the series-connected light-gathering collectors and is heated again to generate high-temperature saline water, which enters the heating chamber to serve as the heat source for the evaporation process; in the evaporation process, high-temperature saline water provides phase change heat for hot saline water and then enters the negative pressure evaporation link, and the limited negative pressure below atmospheric pressure is adopted, which not only reduces the energy consumption and realizes energy saving, but also enables the temperature difference between the evaporated saline water and the high-temperature saline water serving as a heat source to realize continuous evaporation and obtain vapor quantity, and at the same time enables the evaporated saline water, that is, the concentrated solution, to reach the set salinity, that is, it is close to saturated salinity, which is convenient for obtaining crystal salt; the concentrated solution passes through the buffer chamber and then enters the concentrated saline water tank to avoid the water hammer phenomenon in the evaporation chamber and ensure the normal operation of the equipment; in the condensation process, low-temperature saline water stock solution and high-temperature vapor are used for natural convection heat exchange, and the saline water stock solution enters the solar heat collector after heat exchange and temperature rise, so as to speed up the cycle process of heat collection and temperature rise, realize the recycling of vapor energy without consuming energy and water resources to obtain condensed fresh water, accelerate the system operation and improve the condensation efficiency, which not only saves energy and emission, but also saves water resources.

The present application realize a closed circulation system of “series-parallel heat collection→light-gathering heat collection→micro-negative pressure evaporation→self-convection condensation→series-parallel heat collection”, and that whole process mainly rely on natural flow driven by solar heat and potential energy difference to realize rapid heating evaporation and condensation of saline water, thus greatly saving energy consumption; micro-negative pressure reduces the energy consumption of vacuum pump, effectively recovers vapor energy, and can obtain fresh water and crystal salt without additional energy and water resources, which effectively saves energy and consumption and water resources. The whole system has the advantages of cost saving, energy saving and emission reduction, water saving and consumption reduction, high treatment efficiency and wide applicability, and is suitable for islands, coastal areas and arid/semi-arid areas with water shortage.

### BRIEF DESCRIPTION OF DRAWINGS

The accompanying drawings, which constitute a part of the present application, are used to provide a further understanding of the present application, and the illustrative embodiments of the present application and their descriptions are used to explain the present application, and do not constitute undue limitations on the present application.

FIG. 1 is a schematic diagram of the system for separating water and salt by sequential evaporation of multiple groups of heat collecting devices according to the present application;

FIG. 2 is a schematic flow chart of the method for separating water and salt by sequential evaporation of multiple groups of heat collecting devices according to the present application.

### DETAILED DESCRIPTION OF THE INVENTION

It should be noted that the embodiments in this application and the features in the embodiments can be combined with each other without conflict. The present application will be described in detail with reference to the attached drawings and examples.

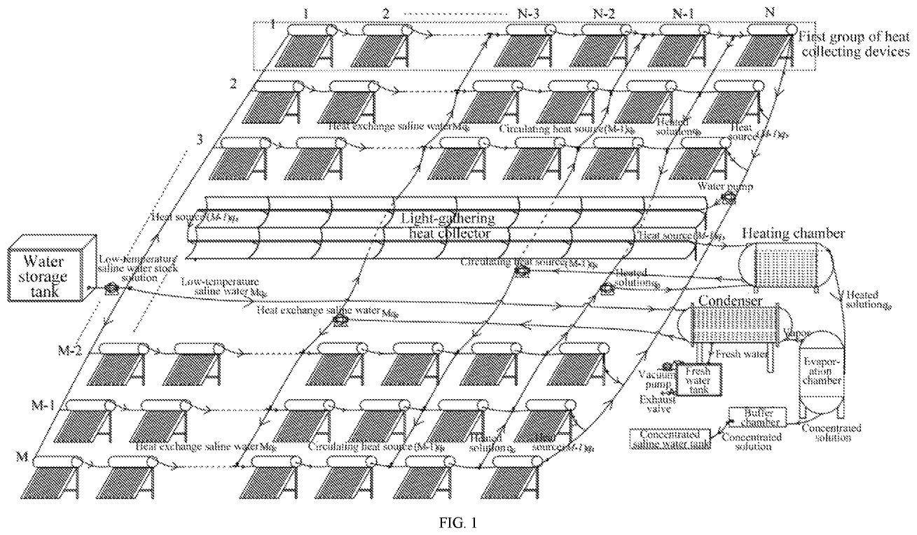

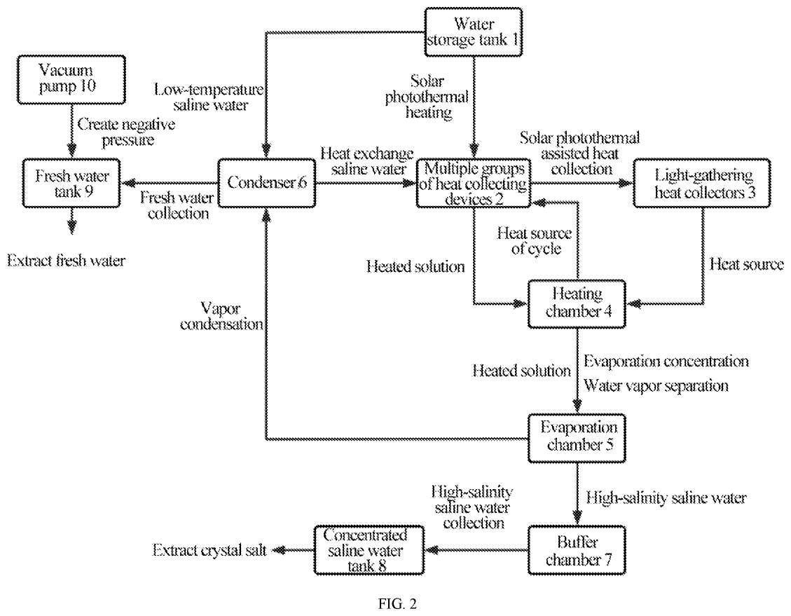

Referring to FIGS. 1 and 2, the embodiment of the present application provides a system for separating water and salt by sequential evaporation of multiple groups of heat collecting devices according to the present application, including a water storage tank 1 and multiple groups of heat collecting devices 2, light-gathering heat collectors 3, a heating chamber 4, an evaporation chamber 5, a condenser 6, a buffer chamber 7, a concentrated saline water tank 8, a fresh water tank 9 and a vacuum pump 10; wherein, the water storage tank 1 is configured for storing a low-temperature saline water stock solution, and an outlet of the water storage tank 1 is connected with a three-way tube to form two paths, one path being connected with an inlet of an inner tube of the condenser 6, and the other path being connected with an inlet of a first heat collector of each group of heat collecting devices 2; the system comprises M groups of heat collecting devices 2, each group of heat collecting devices 2 consisting of N heat collectors connected in series, there are a total of MN heat collectors, and the M groups of heat collecting devices 2 are connected in parallel; the light-gathering heat collector 3 consists of a parabolic lens and a vacuum tube, and is arranged between the heat collecting device 2 and the heating chamber 4 as an auxiliary heating device; an inlet of the light-gathering heat collector 3 is connected with an outlet of a N^{th} heat collector of each heat collecting device 2; an outlet of the light-gathering heat collector 3 is connected with a shell-side inlet of the heating chamber 4, and a communication port is provided with a non-return control valve with a flowmeter; the heating chamber 4 has a shell-and-tube structure, a tube-side inlet of the heating chamber 4 is connected with an outlet of a

$$INT {⌊ \frac{{T}_{v} - {T}_{1}}{{T}_{v} - {T}_{0}} N + 1 ⌋}_{th}$$

heat collector of each group of heat collecting devices 2, and each communication port is provided with a non-return control valve with a flowmeter; a shell-side outlet of the heating chamber 4 is connected with an inlet of a

$$INT {⌊ \frac{( {T}_{v} + α ) - {T}_{1}}{( {T}_{v} + α ) - {T}_{0}} N + 1 ⌋}_{th}$$

heat collector of each group of heat collecting devices, where INT└ ┘ is a rounding down symbol, Tᵥ is a phase change temperature of saline water corresponding to a given evaporation chamber pressure, T₀ is a given initial stock solution temperature, T₁ is an outlet temperature of the first heat collector; where α is a temperature margin, taking 2-4° C.; an inlet of the evaporation chamber 5 is connected with the tube-side outlet of the heating chamber 4; the evaporation chamber 5 has two outlets, a top vapor outlet being connected with the condenser 6, and a bottom concentrated solution outlet is connected with the buffer chamber 7; the condenser 6 has a sleeve-type structure, a tube ring inlet between an inner tube and an outer tube is connected with the vapor outlet of the evaporation chamber 5, and a tube ring outlet is connected with the fresh water tank 9; an inlet of the inner tube is connected with the water storage tank 1, and an outlet is connected with an inlet of a

$$INT {⌊ \frac{{T}_{c} - {T}_{1}}{{T}_{c} - {T}_{0}} N + 1 ⌋}_{th}$$

heat collector of each heat collecting device 2, where T_{c} is an outlet temperature of the condenser 6; a mathematical expression for determining the outlet temperature is as follows:

$${T}_{c} = {T}_{0} + \frac{r}{{c}_{p} ( M - 1 )}$$

where cₚ is a specific heat capacity of saline water, r is latent heat of vapor corresponding to a pressure Pᵥ; the outlet of the buffer chamber is provided with a floating ball self-opening valve, which is connected with the concentrated saline water tank 8; the top of that fresh wat tank 9 is provided with a suction port of the vacuum pump 10 and the bottom is provide with an exhaust valve; the vacuum pump 10 is connected to the top of the fresh water tank 9, so that the evaporation chamber 5 and tube rings of the condenser 6 are in a micro-negative pressure environment.

It should be noted that in this embodiment, the non-return control valve (not shown in the figure) is a valve for preventing the liquid from flowing backwards, and the flow rate of the liquid is controlled by the flowmeter and the control valve here. In addition, because the heat source provided by the heat collecting devices 2 is sufficient, the temperature of the liquid to be phase-changed and the energy for phase change are also sufficient, and the liquid to be phase-changed in the present application is the heated solution shown in FIGS. 1 and 2; therefore, the vacuum pump 10 only needs to provide a negative pressure environment below atmospheric pressure to achieve the concentration of near-saturated salinity and generate a preset amount of vapor, thereby reducing power consumption and reducing dependence on electricity and vacuum.

In this embodiment, the M groups of heat collecting devices 2 are arranged in parallel, and each group of heat collecting devices is cascade-connected by N vacuum tube-type heat collectors in series, and each heat collector is mainly composed of several vacuum heat-collecting tubes and a water tank; the water tank of the first heat collector is filled with water body; a cross-sectional area of the water body of the water tank of the first heat collector is A₁, and a cross-sectional area of the water body of the water tank of a i(=1˜N−1)^{th} heat collector is

$${A}_{i} = ( 1 - \frac{i - 1}{N} ) {A}_{1} ,$$

a cross-sectional area of the water body of the water tank of a i+1^{th} heat collector is smaller than that of a i^{th} heat collector by

$$\frac{{A}_{1}}{N} ,$$

and water levels are gradually decreasing; a bottom height h₁ of the outlet of the water tank of the heat collector first heat collector is flush with the water level of the second heat collector, and a bottom height hᵢ of the outlet of the water tank of the i(=2˜N)^{th} heat collector is determined by the following formula:

$$\frac{i - 1}{N} {A}_{1} = 2 {\int }_{{h}_{i}}^{2 R} \sqrt{{R}^{2} - {( y - R )}^{2}} dy 0 < {h}_{i} < 2 R$$

where R is a cross-sectional radius of the water tank, y is a vertical direction, and upward is positive; a water outlet control valve is arranged at the outlet of the water tank of the first heat collector of each group of heat collecting devices 2, and a temperature sensor is arranged below a water surface of the water tank of the N^{th} heat collector; when the temperature sensor in the N^{th} heat collector measures the water temperature as T_{N}≥T_{b}±2° C., where T_{b} is a boiling point temperature of saline water corresponding to a given initial salinity C₀ and an atmospheric pressure, the water outlet control valve is opened, the saline water with a temperature higher than T₀+ΔT₁ in an upper part of the water tank of first heat collector flows into the bottom of the water tank of the second collector, the water level of the water tank of the second heat collector rises accordingly, and the saline water higher than the bottom height of the outlet flows into a third heat collector from the outlet; therefore, the water body of the water tank of a i(=3˜N−1)^{th} heat collector flows into the water tank of a i+1^{th} heat collector by itself, and finally the water tank of the N^{th} heat collector receives the high-temperature saline water flowing from the water tank of a N−1^{th} heat collector by itself, and the saline water then enters the light-gathering heat collector 3, so that the water temperature can be further increased to meet the temperature requirements of a heat source; and the temperature of saline water flowing from the water tank of the i(=1˜N−1)^{th} heat collector is the same as a lowest temperature of saline water in the water tank of the i+1^{th} heat collector.

It should be noted that, according to the setting of the water level relationship of each collector water tank given in this embodiment, the temperature rise can be doubled, thus greatly improving the operation rate of the system and the saline water treatment efficiency.

In this embodiment, a water inlet control valve is arranged at the inlet of the water tank of the first heat collector of the m(=1˜M)^{th} group of heat collecting devices 2, and water level sensors are arranged at the bottom heights of the water outlets of the water tanks of the N−1^{th} and N^{th} heat collectors respectively; when the water level sensor of the water tank of the N−1^{th} or N^{th} heat collector senses that the water level is lower than the bottom height of the outlet of the water tank, the water inlet control valve is opened, and the water storage tank 1 starts to add water to the first heat collector water tank, until the water level sensor senses that the water level is replenished, and then the water inlet control valve is closed; the inlet water level control in each group of heat collecting devices 2 takes precedence over the outlet temperature control, and the two types of control are allowed to be triggered simultaneously; a height of the outlet of the light-gathering heat collector 3 is higher than that of the shell-side inlet of the heating chamber 4; a height of the tube ring inlet of the condenser 6 is higher than that of the vapor outlet of the evaporation chamber 5, a height of the tube ring outlet of the condenser 6 is higher than that of the inlet of the fresh water tank 9, a height of the outlet of the concentrated solution of the evaporation chamber 5 is higher than that of the inlet of the buffer chamber 7, and a height of the outlet of the buffer chamber 7 is higher than that of the inlet of the concentrated saline water tank 8.

It should be noted that the simultaneous monitoring of water level control and temperature control can prevent the outflow of low-temperature saline water that does not meet the set requirements, and prevent the water in the water tank from being insufficient to provide the heat source or heated liquid needed for the next round. The height relationship among the condenser 3, the heating chamber 4, the evaporation chamber 5, the condenser 6, the buffer chamber 7 and the fresh water tank 9 is set in order to realize natural flow by gravity, and there is no need for external power and other energy sources to provide the power for flow, thus realizing energy saving and consumption reduction.

Based on the above system, the embodiment of the present application also provides a method for separating water and salt by sequential evaporation of multiple groups of heat collecting devices, including the following steps:
(1) heat temperature rise of multi groups of heat collecting devices: low-temperature saline water stock solution is heated to raise a temperature of the saline water in a manner of two light-gathering heat temperature rise modes by series-connected-multiple groups of parallel solar heat collecting devices and series-connected light-gathering heat collectors with decreasing water levels;
(2) micro-negative pressure sequential evaporation: the saline water heated in the step (1) passes through a heating chamber and an evaporation chamber to realize micro-negative pressure evaporation, and vapor and a concentrated solution of extractable crystal salt are obtained;
(3) self-convection phase change condensation: the vapor obtained in the step (2) is further introduced into a condenser 6, and fresh water is obtained by phase change through reverse self-convection heat exchange with a low-temperature saline water stock solution, and at the same time, the low-temperature saline water stock solution obtains a certain temperature rise, enters the heat collecting device 2, and continues to participate in light-gathering heat temperature rise;
(4) cycle operation: a first system cycle of steps (1) to (3) is completed, and M times of cycles are repeated so that the sequential evaporation of the saline water stock solution in each group of heat collecting devices 2 can be completed, and water vapor separation, fresh water and concentrated saline water collection can be continuously carried out.

In this embodiment, in step (1), the heat temperature rise of the multiple groups of heat collecting devices is specifically as follows: a group of heat collecting devices 2 is formed by connecting N solar heat collectors in series, with a total of M groups of heat collecting devices 2; a temperature rise of a i(=1˜N)^{th} heat collector of each group of heat collecting devices 2 is

$$Δ {T}_{i} = \frac{{V}_{1}}{{V}_{i}} \cdot Δ {T}_{1} ,$$

a temperature rise of a first heat collector is

$$Δ {T}_{1} = \frac{{V}_{N}}{{V}_{1}} Δ {T}_{N} ,$$

where ΔT_{N} a given temperature rise of a N^{th} heat collector, V₁, Vᵢ, V_{N} are the water quantities of the first, i^{th} and N N^{th} heat collectors respectively; the heat received by the unit water body in i+1^{th} water tank is higher than that in a i(=1˜N−1)^{th} water tank by

$$KN Δ {T}_{1} ( \frac{1}{N - i} - \frac{1}{N - i + 1} ) ,$$

where K is a heat transfer coefficient; the light-gathering heat collector 3 is an auxiliary heating device, and the saline water in the N^{th} heat collector of each group of heat collecting devices 2 first flows through the light-gathering heat collector 3 to absorb solar light to be heated again, so that the temperature of the heat source entering a shell side of the heating chamber 4 T_{con}≥T_{b}, where T_{con} is an outlet temperature of the light-gathering heat collector 3.

It should be noted that the light-gathering heat collector 3, as an auxiliary heating device, ensures that the temperature of saline water serving as a heat source in the front-end heat collector reaches a preset value, so as to ensure the evaporation concentration effect at the tailing end.

In this embodiment, in step (2), the sequential evaporation by micro-negative pressure is specifically as follows: the saline water in a

$$INT {⌊ \frac{{T}_{v} - {T}_{1}}{{T}_{v} - {T}_{0}} N + 1 ⌋}_{th}$$

heat collector of a m(=1˜M)^{th} group of heat collecting devices is rotated in a sequence of 1˜M, and enters a tube side of the heating chamber 4 to serve as a liquid to be phase-changed, and at the same time an outlet valve of the N^{th} heat collector of the group of heat collecting devices 2 is closed; saline water with a temperature of T_{b} in the N^{th} heat collector of the other M−1 groups of heat collecting devices except the m^{th} group flows through the light-gathering heat collector, that is, the saline water naturally flows from an outlet of the light-gathering heat collector 3 into the inlet of the shell side of the heating chamber as the heat source of the shell side of the heating chamber 4 to heat the heated liquid in the tube side of the heating chamber 4; a flow rate of one part of the liquid to be phase-changed with a flow quantity of q₀ and a temperature of Tᵥ circulating in the tube side of the heating chamber 4 is controlled as u₀, a flow rate of the heat source with a flow quantity of (M−1)qₛ and a temperature of T_{b} circulating in the shell side is controlled as uₛ, the relationship between the two flow rates satisfying

$$\frac{{u}_{s}}{{u}_{0}} = \frac{2}{M - 1} \frac{r ( 1 - {C}_{0} / {C}_{1} )}{{c}_{p} [ {T}_{b} - ( {T}_{v} + α ) ]} ,$$

where C₀ and C₁ are respectively an initial salinity of saline water to be phase-changed and a salinity of concentrated solution, and the salinity C₁ is close to saturation salinity; the saline water as a heat source flows out of the heating chamber after heat transfer and cooling, returns to a

$$INT {⌊ \frac{( {T}_{v} + α ) - {T}_{1}}{( {T}_{v} + α ) - {T}_{0}} N + 1 ⌋}_{th}$$

heat collector of the M−1^{th} group of heat collecting devices 2 as a heat source according to a flow quantity of qₛ per part, and continues to participate in the sequential heating; after the sequential starting, the saline water entering the tube side of the heating chamber 4 as the liquid to be phase-changed flows out of the heating chamber 4 and enters the evaporation chamber 5, and the evaporation chamber 5 performs evaporation and water-vapor separation for one part of the vapor-containing saline water to be phase-changed with a temperature of Tᵥ that flows out of the tube of the heating chamber 4 under a given negative pressure Pᵥ; the vapor in the evaporation chamber 5 is discharged from the outlet at the top of the evaporation chamber 5 and flows between the tube rings of the condenser 6; the remaining saline water whose salinity is concentrated to C₁ flows into a buffer chamber 7 controlled by a float self-opening valve through the outlet at the bottom of the evaporation chamber 5; when a weight of the saline water in the buffer chamber 7 reaches a preset value, the float valve is self-opened under pressure, and then the concentrated solution with a nearly saturated salinity flows into a concentrated saline water tank 8 for extracting crystal salt.

It should be noted that the temperature of the saline water as a heat source in the heating chamber 4 is still high after heat exchange with the heated solution, and this part of the saline water with a higher temperature is returned to the front-end heat collector 2 in proportion, which improves the energy utilization and accelerates the front-end heat collection and temperature rise cycle. In addition, the saline water in each group of heat collecting devices 2 is pumped out in turn and enters the heating chamber to serve as the liquid to be phase-changed and the heat source, so that the saline water in each group of heat collecting devices 2 will not be repeatedly heated and circulated, and new saline water will flow into each group to participate in the heating flow, with a high replacement rate, which avoids the salt precipitation of the saline water in the heat collecting devices 2 due to repeated heating, and further avoids the problems of shortening the service life of the equipment, increasing the running resistance of the equipment, slowing down the system processing rate and the like.

It should also be noted that the setting of the buffer chamber 7 is to prevent heavy water hammer caused by sudden opening and closing of the outlet of the evaporation chamber and ensure the normal operation of the equipment; the weight of the saline water in the buffer chamber 7 will increase due to the salinity change and the content change of the saline water. When it increases to a preset value, the ball valve will automatically open under a sufficient pressure, and the concentrated solution in the buffer chamber 7 will then slowly and naturally flow to the concentrated saline water tank 8. The salinity of the saline water collected in the concentrated saline water tank 8 is close to the saturation salinity, which is convenient for extracting the crystal salt.

In this embodiment, in the step (3), the self-convection phase change condensation is specifically as follows: the condenser 6 is divided into a tube ring vapor passage and an inner tube saline water passage; the vapor in the tube ring passage enters the tube ring from a lower inlet of the condenser 6, naturally floats from bottom to top, and is condensed into fresh water by exothermic phase change, and then flows into the fresh water tank 9 through a water inlet at a lower end of the tube ring passage; the low-temperature saline water stock solution in the inner tube passage is provided by the water storage tank 1, enters an inner tube from an inlet at an upper end of the condenser 6, naturally flows from top to bottom, and forms natural counter-convection with the vapor in the tube ring passage, a total amount of the low-temperature saline water stock solution being Mq_{c}; the low-temperature saline water stock solution in the inner tube passage flows out from the outlet at the lower end of the inner tube passage after exchanging heat with vapor and heating, and flows into a

$$INT {⌊ \frac{{T}_{c} - {T}_{1}}{{T}_{c} - {T}_{0}} N + 1 ⌋}_{th}$$

heat collector of the M^{th} group of heat collecting devices 2 according to a flow quantity of q_{c} per part to participate in sequential heating; the fresh water tank 9 is configured for storing fresh water which is formed by the phase change of vapor in the condenser 6, and the fresh water tank 9 is provided with an exhaust valve which is always closed when the system is running to maintain the negative pressure environment of the evaporation chamber 5 and the condenser 6; at the end of the system operation, the exhaust valve is opened, so that the air pressure in the fresh water tank 9 becomes a normal pressure and fresh water flows out.

It should be noted that the cooling water exchanged with vapor in the condenser 6 is taken as the low-temperature saline water stock solution, and this part of saline water enters the front-end heat collecting device 2 in proportion after heat exchange and temperature rise, that is, the condensation process does not need additional water resources, which accelerates the front-end heating process while saving energy, improves the operation rate of the system and increases the energy utilization rate.

What has been described above is only the preferred embodiment of the present application, and it is not used to limit the present application. For those skilled in the art, the present application may have various modifications and changes. Any modification, equivalent substitution, improvement and the like made within the spirit and principle of the present application shall be included in the protection scope of the present application.

1. A system for separating water and salt by sequential evaporation of multiple groups of heat collecting devices, comprising a water storage tank, multiple groups of heat collecting devices, light-gathering heat collectors, a heating chamber, an evaporation chamber, a condenser, a buffer chamber, a concentrated saline water tank, a fresh water tank and a vacuum pump; wherein the water storage tank is configured to store a low-temperature saline water stock solution, and an outlet of the water storage tank is connected to a three-way tube to form two paths, one path is connected to an inlet of an inner tube of the condenser, and the other path is connected to an inlet of a first heat collector of each group of the heat collecting devices; wherein the system comprises M groups of heat collecting devices and each group of the heat collecting devices comprises N heat collectors connected in series to constitute M×N heat collectors in total, and the M groups of the heat collecting devices are connected in parallel; wherein the light-gathering heat collector comprises a parabolic lens and a vacuum tube, and is arranged between a heat collecting device and the heating chamber as an auxiliary heating device; wherein an inlet of the light-gathering heat collector is connected to an outlet of an N^{th} heat collector of each of the heat collecting devices; wherein an outlet of the light-gathering heat collector is connected to a shell-side inlet of the heating chamber, and a communication port is provided with a non-return control valve with a flowmeter; wherein the heating chamber is in a shape of a shell-and-tube structure, a tube-side inlet of the heating chamber is connected to an outlet of a
$$INT {⌊ \frac{{T}_{v} - {T}_{1}}{{T}_{v} - {T}_{0}} N + 1 ⌋}^{th}$$
heat collector of each group of the heat collecting devices, and each communication port is provided with a non-return control valve with a flowmeter, and a shell-side outlet of the heating chamber is connected to an inlet of a
$$INT {⌊ \frac{( {T}_{v} + α ) - {T}_{1}}{( {T}_{v} + α ) - {T}_{0}} N + 1 ⌋}^{th}$$
heat collector of each group of the heat collecting devices, where INT└ ┘ is a rounding down symbol, Tᵥ is a phase change temperature of saline water corresponding to a given evaporation chamber pressure, T₀ is a given initial stock solution temperature, T₁ is an outlet temperature of the first heat collector; where α is a temperature margin, within a range of 2-4° C.; wherein an inlet of the evaporation chamber is connected to a tube-side outlet of the heating chamber, the evaporation chamber is provided with two outlets, including a vapor outlet at a top of the evaporation chamber and a concentrated solution outlet at a bottom of the evaporation chamber, wherein the top vapor outlet is connected to the condenser, and the bottom concentrated solution outlet is connected to the buffer chamber; wherein the condenser is in a sleeve-type structure, an inlet of a tube ring between an inner tube and an outer tube is connected to the vapor outlet of the evaporation chamber, and an outlet of the tube ring is connected to the fresh water tank; wherein an inlet of the inner tube is connected to the water storage tank, and an outlet of the inner tube is connected to an inlet of a
$$INT {⌊ \frac{{T}_{c} - {T}_{1}}{{T}_{c} - {T}_{0}} N + 1 ⌋}^{th}$$
heat collector of each heat collecting device, where T_{c} is an outlet temperature of the condenser; a mathematical expression for determining the outlet temperature is as follows:
$${T}_{c} = {T}_{0} + \frac{r}{{c}_{p} ( M - 1 )}$$
where cₚ is a specific heat capacity of saline water, r is latent heat of vapor corresponding to a pressure Pᵥ; and
wherein an outlet of the buffer chamber is provided with a floating ball self-opening valve connected to the concentrated saline water tank, a suction port of the vacuum pump is provided at a top of the fresh water tank, an exhaust valve is provided at a bottom of the fresh water tank, and the vacuum pump is connected to the top of the fresh water tank, in such a manner that the evaporation chamber and the tube ring of the condenser are in a micro-negative pressure environment.

2. The system for separating water and salt by sequential evaporation of multiple groups of heat collecting devices, wherein the M groups of heat collecting devices are arranged in parallel, each group of the heat collecting devices is cascade-connected by N vacuum tube-type heat collectors in series, and each of the heat collectors includes multiple vacuum heat-collecting tubes and a water tank; wherein a water tank of a first heat collector is filled with water body, where a cross-sectional area of the water body in the water tank of the first heat collector is A₁, and a cross-sectional area of water body in a water tank of an i^{th} heat collector is
$${A}_{i} = ( 1 - \frac{i - 1}{N} ) {A}_{1} ,$$
where i=1˜(N−1), a cross-sectional area of water body of a water tank of an (i+1)^{th} heat collector is smaller than the cross-sectional area of the water body of the water tank of the i^{th} heat collector by
$$\frac{{A}_{1}}{N} ,$$
and a water level of the water tank of the (i+1)^{th} heat collector is lower than a water level of water tank of an i^{th} heat collector, where i=1˜(N−1), and a bottom height h₁ of an outlet of the water tank of the first heat collector is flush with a water level of a water tank of a second heat collector, and a bottom height hᵢ of the outlet of the water tank of the i^{th} heat collector is determined by, where i=2˜N:
$$\frac{i - 1}{N} {A}_{1} = 2 {\int }_{{h}_{i}}^{2 R} \sqrt{{R}^{2} - {( y - R )}^{2}} dy$$
where 0<hᵢ<2R, R is a cross-sectional radius of a water tank, y represents a vertical direction, with an upward direct as a positive direct; a water outlet control valve is arranged at the outlet of the water tank of the first heat collector of each group of the heat collecting devices, and a temperature sensor is arranged below a water surface of a water tank of an N^{th} heat collector; when a water temperature measured by the temperature sensor in the N^{th} heat collector is T_{N}≥T_{b}±2° C., where T_{b} is a boiling point temperature of saline water corresponding to a given initial salinity C₀ and an atmospheric pressure, the water outlet control valve is opened, saline water with a temperature higher than T₀+ΔT₁ in an upper part of the water tank of first heat collector automatically flows into a bottom of the water tank of the second collector, the water level of the water tank of the second heat collector rises, and saline water higher than a bottom height of an outlet of the water tank of the second heat collector automatically flows into a bottom of the water tank of the third heat collector from the outlet of the water tank of the second heat collector, water body of a water tank of an i^{th} heat collector automatically flows into a water tank of an (i+1)^{th} heat collector, where i=3˜(N−1), . . . , and a water tank of an N^{th} heat collector receives saline water with a high temperature automatically flowing from a water tank of an (N−1)^{th} heat collector, and the saline water received by a water tank of an N^{th} heat collector enters the light-gathering heat collector, so as to increase the water temperature meet a temperature requirement of a heat source; and a temperature of saline water flowing from the water tank of the i^{th} heat collector is equal to a lowest temperature of saline water in the water tank of the (i+1)^{th} heat collector, where i=1˜(N−1).

3. The system for separating water and salt by sequential evaporation of multiple groups of heat collecting devices according to claim 1, wherein a water inlet control valve is arranged at the inlet of the water tank of the first heat collector of the m^{th} group of heat collecting devices, where m=1˜M, and each bottom height of the water outlets of the water tanks of the (N−1)^{th} and N^{th} heat collectors are provided with a water level sensor, respectively; when the water level sensor of the water tank of the (N−1)^{th} or N^{th} heat collector senses that the water level is lower than the bottom height of the outlet of the water tank of the (N−1)^{th} or N^{th} heat collector, the water inlet control valve is opened, and the water storage tank starts to add water to the first heat collector water tank until the water level sensor senses that the water level is replenished, and the water inlet control valve is closed; wherein controlling an inlet water level of each group of the heat collecting devices takes precedence over controlling an outlet temperature of each group of the heat collecting devices, and the two types of controlling are allowed to be triggered simultaneously; a height of the outlet of the light-gathering heat collector is higher than a height of the shell-side inlet of the heating chamber; a height of the tube ring inlet of the condenser is higher than a height of the vapor outlet of the evaporation chamber, a height of the tube ring outlet of the condenser is higher than a height of the inlet of the fresh water tank, a height of the concentrated solution outlet of the evaporation chamber is higher than a height of the inlet of the buffer chamber, and a height of the outlet of the buffer chamber is higher than a height of the inlet of the concentrated saline water tank.

4. A method for separating water and salt by sequential evaporation of multiple groups of heat collecting devices, comprising:
step (1) heat temperature rise of multi groups of heat collecting devices: low-temperature saline water stock solution is heated to raise a temperature of the saline water in a manner of two light-gathering heat temperature rise modes by series-connected-multiple groups of parallel solar heat collecting devices and series-connected light-gathering heat collectors with decreasing water levels;
step (2) micro-negative pressure sequential evaporation: the saline water heated in the step (1) passes through a heating chamber and an evaporation chamber to be evaporated at a micro-negative pressure, and vapor and a concentrated solution of extractable crystal salt are obtained;
step (3) self-convection phase change condensation: the vapor obtained in the step (2) is further introduced into a condenser, and fresh water is obtained by phase change through reverse self-convection heat exchange with a low-temperature saline water stock solution, a temperature of the low-temperature saline water stock solution rises and the low-temperature saline water stock solution enters the heat collecting device, and continues to participate in light-gathering heat temperature rise; and
step (4) cycle operation: a first system cycle of the steps (1) to (3) is completed, and M times of cycles are repeated in such a manner that the low-temperature saline water stock solution in each group of heat collecting devices is sequentially evaporated, vapor is separated from water continuously, and fresh water and concentrated saline water are collected continuously.

5. The method for separating water and salt by sequential evaporation of multiple groups of heat collecting devices according to claim 4, wherein in the step (1), the heat temperature rise of the multiple groups of heat collecting devices comprises: forming one group of heat collecting devices by connecting N solar heat collectors in series, with a total of M groups of heat collecting devices, a temperature rise of a i(=1˜N)^{th} heat collector of each group of heat collecting devices being
$$Δ {T}_{i} = \frac{{V}_{1}}{{V}_{i}} \cdot Δ {T}_{1} ,$$
a temperature rise of a first heat collector being
$$Δ {T}_{1} = \frac{{V}_{N}}{{V}_{1}} Δ {T}_{N} ,$$
where ΔT_{N} is a given temperature rise of a N^{th} heat collector, V₁, Vᵢ, V_{N} are the water quantities of a first, i^{th} and N^{th} heat collectors, respectively, heat received by a water body unit in (i+1)^{th} water tank is higher than heat in a i(=1˜N−1)^{th} water tank by
$$KN Δ {T}_{1} ( \frac{1}{N - i} - \frac{1}{N - i + 1} ) ,$$
where K is a heat transfer coefficient, wherein a light-gathering heat collector works as an auxiliary heating device, and saline water in the N^{th} heat collector of each group of heat collecting devices first flows through the light-gathering heat collector to absorb solar light to be heated again, in such a manner that a temperature of a heat source of a shell side of the heating chamber satisfies T_{con}≥T_{b}, where T_{con} is an outlet temperature of the light-gathering heat collector, and T_{b} is a boiling point temperature of saline water corresponding to a given initial salinity C₀ and an atmospheric pressure.

6. The method for separating water and salt by sequential evaporation of multiple groups of heat collecting devices according to claim 4, wherein in the step (2), the sequential evaporation by micro-negative pressure comprises: saline water in a
$$INT {⌊ \frac{{T}_{v} - {T}_{1}}{{T}_{v} - {T}_{0}} N + 1 ⌋}^{th}$$
heat collector of a m(=1˜M)^{th} group of heat collecting devices being rotated in a sequence of 1˜M, and entering a tube side of the heating chamber to be liquid to be phase-changed, and closing an outlet valve of the N^{th} heat collector of the m(=1˜M)^{th} group of heat collecting devices, wherein saline water with a temperature of T_{b} in the N^{th} heat collector of the other M−1 groups of heat collecting devices except an m^{th} group flows through the light-gathering heat collector, that is, naturally flows from an outlet of the light-gathering heat collector into the inlet of the shell side of the heating chamber as the heat source of the shell side of the heating chamber to heat heated liquid in the tube side of the heating chamber, wherein a flow rate of one share of the liquid to be phase-changed with a flow quantity of q₀ and a temperature of Tᵥ circulating in the tube side of the heating chamber is controlled as u₀, a flow rate of a heat source with a flow quantity of (M−1)qₛ and a temperature of T_{b} circulating in the shell side is controlled as uₛ, and a relationship between u₀ and uₛ satisfies
$$\frac{{u}_{s}}{{u}_{0}} = \frac{2}{M - 1} \frac{r ( 1 - {C}_{0} / {C}_{1} )}{{c}_{p} [ {T}_{b} - ( {T}_{v} + α ) ]} ,$$
where C₀ and C₁ are an initial salinity of saline water to be phase-changed and a salinity of concentrated solution, respectively, and C₁ is close to saturation salinity, wherein the saline water as the heat source flows out of the heating chamber after heat transfer and cooling, returns to an
$$INT {⌊ \frac{( {T}_{v} + α ) - {T}_{1}}{( {T}_{v} + α ) - {T}_{0}} N + 1 ⌋}^{th}$$
heat collector of an (M−1) th group of heat collecting devices as a heat source according to a flow quantity of qₛ per part, and continues to participate in sequential heating, wherein after sequential starting, saline water entering the tube side of the heating chamber as the liquid to be phase-changed flows out of the heating chamber and enters the evaporation chamber, and in the evaporation chamber one share of the vapor-containing saline water to be phase-changed with a temperature of Tᵥ that flows out of the tube of the heating chamber evaporates and water is separated from vapor under a given negative pressure Pᵥ, the vapor in the evaporation chamber is discharged from an outlet at a top of the evaporation chamber and flows between tube rings of the condenser, remaining saline water whose salinity is concentrated to C₁ flows into a buffer chamber controlled by a float self-opening valve through an outlet at a bottom of the evaporation chamber, and when a weight of the saline water in the buffer chamber reaches a preset value, a float valve is self-opened under pressure, and the concentrated solution with a nearly saturated salinity flows into a concentrated saline water tank for extracting crystal salt.

7. The method for separating water and salt by sequential evaporation of multiple groups of heat collecting devices according to claim 4, wherein in the step (3), the self-convection phase change condensation satisfies: the condenser comprises a tube ring vapor passage and an inner tube saline water passage, wherein vapor in the tube ring passage enters the tube ring from a lower inlet of the condenser, naturally floats from bottom to top, and condenses into fresh water by exothermic phase change, and flows into a fresh water tank through a water inlet at a lower end of the tube ring passage, low-temperature saline water stock solution in inner tube passage is provided by the water storage tank, enters an inner tube from an inlet at an upper end of the condenser, naturally flows from top to bottom, and forms natural counter-convection with the vapor in the tube ring passage, a total amount of the low-temperature saline water stock solution is Mq_{c}, the low-temperature saline water stock solution in the inner tube passage flows out from an outlet at a lower end of the inner tube passage after exchanging heat with vapor and heating, and flows into
$$INT {⌊ \frac{{T}_{c} - {T}_{1}}{{T}_{c} - {T}_{0}} N + 1 ⌋}^{th}$$
heat collector of M groups of heat collecting devices according to a flow quantity of q_{c} per part to participate in sequential heating, wherein the fresh water tank is configured to store fresh water formed by phase change of vapor in the condenser, the fresh water tank is provided with an exhaust valve, the exhaust valve is always closed when a system is running to maintain negative pressure environment of the evaporation chamber and the condenser, and wherein when operation of the system ends, the exhaust valve is opened, in such a manner that the air pressure in the fresh water tank becomes a normal pressure and fresh water flows out.
